(19) United States
(12) Patent Application Publication
(10) Pub. No.: US 2008/0282175 A1
(43) Pub. Date: Nov. 13, 2008

(54) AUTOMATICALLY ENCODED, GRACEFULLY DEGRADING PANELS

(75) Inventors: Alexandru Costin, Bucuresti (RO); Bogdan Ripa, Vaslui (RO)

Correspondence Address: FISH & RICHARDSON P.C., P.O. Box 1022, MINNEAPOLIS, MN, 55440-1022, US

(73) Assignee: Adobe Systems Incorporated, San Jose, CA (US)

(21) Appl. No.: 11/745,058

(22) Filed: May 7, 2007

(51) Int. Cl. G06F 3/048; G06F 15/00

(52) U.S. Cl. 715/760

(57) ABSTRACT

Automatically encoded, gracefully degrading Asynchronous JavaScript And eXtensible Markup Language (Ajax) panels, in which states of an Ajax panel are rendered in a web browser using either an automatically-encoded JavaScript code portion or an automatically-encoded non-JavaScript code portion of a web document, based on an automatic determination of a JavaScript capability of the web browser.

### FIELD

The present disclosure generally relates to client-server communication, and at least one particular implementation relates to automatically-encoded, gracefully degrading Asynchronous JavaScript And XML (Ajax) panels.

### BACKGROUND

Rich Internet Applications (RIAs) are web applications that have the features and functionality of traditional desktop applications. RIAs typically transfer the processing necessary for the user interface to the web client, but keep the bulk of the data on the application server.

Dynamic web documents, such as those used for RIAs, may be produced using the Hypertext Preprocessor (PHP) reflective programming language, or using an Ajax framework. Ajax may be used, for example, to make dynamic web documents feel more responsive by exchanging small amounts of data with the server, instead of reloading an entire web document each time the user requests a change.

### SUMMARY

According to one general implementation, states of an Ajax panel are rendered in a web browser using either an automatically-encoded JavaScript code portion or an automatically-encoded non-JavaScript code portion of a web document, based on an automatic determination of a JavaScript capability of the web browser.

In general, an Ajax panel refers to a discrete, visible portion of a rendered web document that includes controls, links, widgets or other mechanisms that, when manually or automatically selected, cause the visible content of that portion or another discrete visible portion of the web document to change. Thus, in a first state, the changed visible portion may display first content and, in a second state, the changed visible portion may display second content.

According to another general implementation, a web document is automatically encoded based on a selection of a multi-state Ajax panel via a web development application, the encoded web document including a JavaScript code portion and a server scripting language code portion corresponding to the Ajax panel. A JavaScript capability of a web browser is automatically determined, the JavaScript code portion is selectively invoked based on the automatic determination of the JavaScript capability of the web browser, the state of at least the Ajax panel is changed based on a selection of the Ajax panel via the web browser, and further based on the selectively invoked JavaScript code portion or the server scripting language code portion, and the Ajax panel is rendered.

Implementations may include one or more of the following features. For example, automatically encoded web document may be transmitted from a server to a client operating the web browser. Changing the state of at least the Ajax panel based on the server scripting language code portion may further include transmitting a request from the client to the server using GET variables. Automatically determining a JavaScript capability of the web browser may further include automatically determining whether the web browser is a fourth generation or later web browser, or automatically determining whether JavaScript is disabled or missing, where the JavaScript code portion may be invoked if it is automatically determined that JavaScript is not disabled or missing, and where the server scripting language code portion may be invoked if it is automatically determined that JavaScript is disabled or missing.

In further examples, the Ajax panel further includes an Ajax control or an Ajax widget. The server scripting language may be PHP. Selectively invoking the JavaScript code portion or the server scripting language code portion based on the automatic determination of the JavaScript capability of the web browser may effectuate graceful degradation of the encoded web document. The selection of the Ajax panel via the web development application may include a user selection of an Ajax panel template or an Ajax panel wizard, where the web development application may be the ADOBE® DREAMWEAVER® web development application or another What You See Is What You Get (WYSIWYG) web development application. Alternatively, the Ajax panel may be hand-coded in a PHP document, without using an integrated development environment (IDE).

The state of the Ajax panel may be serialized in a Uniform Resource Locator (URL) of the web document using a hash or using GET variables. A selection of the Ajax panel via the web browser may be intercepted, such as when a user clicks a link intended to change the state of the Ajax panel, and a default action of the selection of the Ajax panel via the web browser may be modified based on the automatic determination of the JavaScript capability of the web browser. Modifying the default action of the selection further may further include modifying a document object model (DOM) structure. Selectively invoking the JavaScript code portion of the web document further may further include assigning an ONCLICK event to a link associated with the Ajax panel, and, on receiving a user selection of the link, changing the state of at least the Ajax panel may further include executing the ONCLICK event if the web browser is automatically determined to include a JavaScript capability, and issuing a HTTP request if the web browser is automatically determined to not include a JavaScript capability.

According to another general implementation, a computer-implemented method includes automatically determining a JavaScript capability of a web browser, selectively invoking a JavaScript code portion of a web document based on the automatic determination of the JavaScript capability of the web browser. The method also includes changing the state of at least the Ajax panel based on a selection of the Ajax panel via the web browser, and further based on the selectively invoked JavaScript code portion or a server scripting language code portion of the web document, and rendering the Ajax panel.

According to another general implementation, a computer-implemented method includes automatically encoding a web document based on a selection of a multi-state Ajax panel via a web development application, the encoded web document including a JavaScript code portion and a server scripting language code portion corresponding to the Ajax panel, the JavaScript code portion and the server scripting language code portion being operable to cause a change of state of at least the Ajax panel based on a selection of the Ajax panel via a web browser.

According to another general implementation, a computer-implemented method includes automatically determining a JavaScript capability of a web browser. A JavaScript code portion of a web document is selectively invoked based on the automatic determination of the JavaScript capability of the web browser, the web document being automatically encoded based on a selection of a multi-state Ajax panel via a web development application. The state of at least the Ajax panel is changed based on a selection of the Ajax panel via the web browser, and further based on the selectively invoked JavaScript code portion or a server scripting language code portion of the web document, and the Ajax panel is rendered.

According to another general implementation, a computer-implemented method includes automatically encoding a web document based on a selection of a multi-state panel via a web development application, the encoded web document including a first code portion and a second code portion corresponding to the panel, and automatically determining a capability of a web browser. The first code portion is selectively invoked based on the automatic determination of the capability of the web browser, the state of at least the panel is changed based on a selection of the Ajax panel via the web browser, and further based on the selectively invoked first code portion or the second code portion, and the panel is rendered.

According to another general implementation, a device includes a processor and a display. The processor is configured to automatically encode a web document based on a selection of a multi-state Ajax panel, the encoded web document including a JavaScript code portion and a server scripting language code portion corresponding to the Ajax panel, to automatically determine a JavaScript capability of a web browser, to selectively invoke the JavaScript code portion based on the automatic determination of the JavaScript capability of the web browser, and to change the state of at least the Ajax panel based on a selection of the Ajax panel via the web browser, and further based on the selectively invoked JavaScript code portion or the server scripting language code portion. The display is configured to render the Ajax panel.

According to another general implementation, a computer program product is tangibly embodied in a machine-readable medium. The computer program product includes instructions that, when read by a machine, operate to cause a data processing apparatus to automatically encode a web document based on a selection of a multi-state Ajax panel, the encoded web document including a JavaScript code portion and a server scripting language code portion corresponding to the Ajax panel, and to automatically determine a JavaScript capability of a web browser. Further, the computer program product also includes instructions that, when read by a machine, operate to cause a data processing apparatus to selectively invoke the JavaScript code portion based on the automatic determination of the JavaScript capability of the web browser, to change the state of at least the Ajax panel based on a selection of the Ajax panel via the web browser, and further based on the selectively invoked JavaScript code portion or the server scripting language code portion, and to render the Ajax panel.

According to another general implementation, a computer program product is tangibly embodied in a machine-readable medium. The computer program product includes instructions that, when read by a machine, operate to cause a data processing apparatus to automatically determine a JavaScript capability of a web browser, and to selectively invoke a JavaScript code portion of a web document based on the automatic determination of the JavaScript capability of the web browser, the web document being automatically encoded based on a selection of a multi-state Ajax panel. Furthermore, the computer program product includes instructions that, when read by a machine, operate to cause a data processing apparatus to change the state of at least the Ajax panel based on a selection of the Ajax panel via the web browser, and further based on the selectively invoked JavaScript code portion or a server scripting language code portion of the web document, and to render the Ajax panel.

The details of one or more implementations are set forth in the accompanying drawings and the description, below. Other potential features and advantages of the disclosure will be apparent from the description and drawings, and from the claims.

### DESCRIPTION OF DRAWINGS

FIG. 1 is a block diagram of an exemplary system, according to one general implementation.

FIG. 2 is a flowchart illustrating an exemplary process for implementing automatically encoded, gracefully degrading Ajax panels, according to another general implementation.

FIG. 3 illustrates the general relationship between the states of an Ajax panel, for an exemplary web document.

FIG. 4 depicts the exterior appearance of an exemplary client device, according to another general implementation.

FIG. 5 depicts an exemplary internal architecture of the device of FIG. 4.

FIGS. 6A to 6C illustrate an exemplary web document in various states.

Like reference numbers represent corresponding parts throughout.

### DETAILED DESCRIPTION

Using the enhanced approach described herein, a web document that includes multi-state panels can be easily created by web developers of all skill levels, where the various states of the panels may be rendered and changed regardless of the JavaScript processing capabilities of the web browser. Where a web browser does not have sufficient JavaScript processing capabilities, the web document will cause the state of a panel to change based on processing that occurs at a server, via a Hyper-Text Transfer Protocol (“HTTP”) request to PHP documents stored on the server. Conversely, where a web browser has sufficient JavaScript processing capabilities, an interaction with the panel is detected and intercepted, and the state of the panel will change based on a selection of the panel via the web browser, and further based on processing that occurs at the client device and content that is retrieved from the server using an XMLHTTPREQUEST. The interaction that is intercepted may be, for example, the user clicking on a link that is supposed to change the state of the panel.

In either case, the appearance of the changed state is the same, fulfilling the promise of graceful degradation. Degradability generally refers to the provision of the essential functions of a web application, irrespective of the capabilities client. In this context, graceful degradation particularly refers to the ability of an application to deliver substantially the same functionality, irrespective of the client capabilities.

JavaScript code may be used to cause the links of the web document to be rewritten by changing or updating the DOM structure in the memory of the web browser. For example, an ONCLICK event can be assigned to various links so that, upon receiving a selection of the link, the ONCLICK event executes to retrieve content using an XMLHTTPREQUEST, thereby updating a portion of the rendered web document. As an alternative to using JavaScript, a user clicking on the link will cause a HTTP command to request a PHP document stored on the server, thereby updating the entire rendered web page.

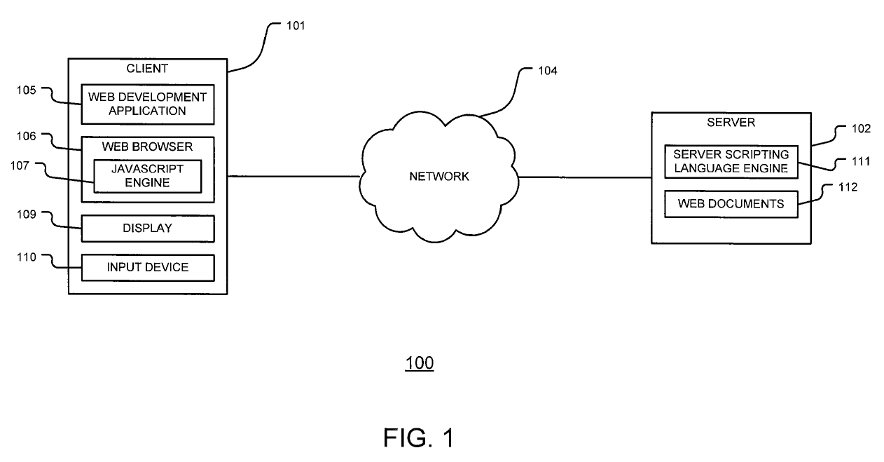

FIG. 1 is a block diagram of an exemplary system 100 used to effectuate gracefully degrading state changes for Ajax panels. Briefly, the system 100 includes a client 101 and a server 102, connected via a network 104. The client 101 includes a web development application 105 and a web browser application 106, which may further include a JavaScript engine 107 that gives the web browser application a JavaScript processing capability. The client 101 also includes a display 109 and an input device 110.

Ajax provides a communication framework between the client 101 and the server 102, allowing portions of a web document to be requested from and sent to the client 101. Using Ajax, it is not necessary for an entire web document to be completely refreshed each time a server request is performed. This framework is different from typical, static web document updating, which requires that the entire contents of the web document be requested from the server and re-sent to the client, irrespective of whether the contents were changed or not.

Further, Ajax provides for a distinction between sections of the web document that change and sections that do not, leading to decreased load times, decreased server load, and increased server throughput. Ajax also allows web documents to load seamlessly, considerably reducing server traffic and the web document loading times. To its advantage, the overall user experience may be improved using Ajax panels, since web users can continue to view static portions of the web document while other portions are loading.

An Ajax panel refers to a discrete, visible portion of a web document that includes controls, links, widgets or other mechanisms that, when manually or automatically selected, cause the visible content of that portion or another discrete visible portion of the web document to change. Thus, in a first state, the changed visible portion may display first content and, in a second state, the changed visible portion may display second content. The first and second content may be stored in separate computer files, may be stored in different portions of a single computer file, may be identical, may be generated locally in real-time, or may be accessed via a network connection.

In one example implementation, a default state is loaded for each Ajax panel upon loading a web document for the first time, such as by using initial panel metadata indicative of the default state of the first panels or by using URL parameters which store the serialized panel states. A change of state occurs when the user clicks on a link on the panel with a mouse (or uses an equivalent keyboard keystroke). If JavaScript is enabled, the links are converted to Ajax links or controls, causing a partial page reload. An Ajax panel can include any Ajax control, such as an accordion, a tabset, a collapsible region, a photo gallery, a dynamic table, a sorting component, a navigation component, a dialog box, a tooltip, a rating component, a suggest text field component, or other component.

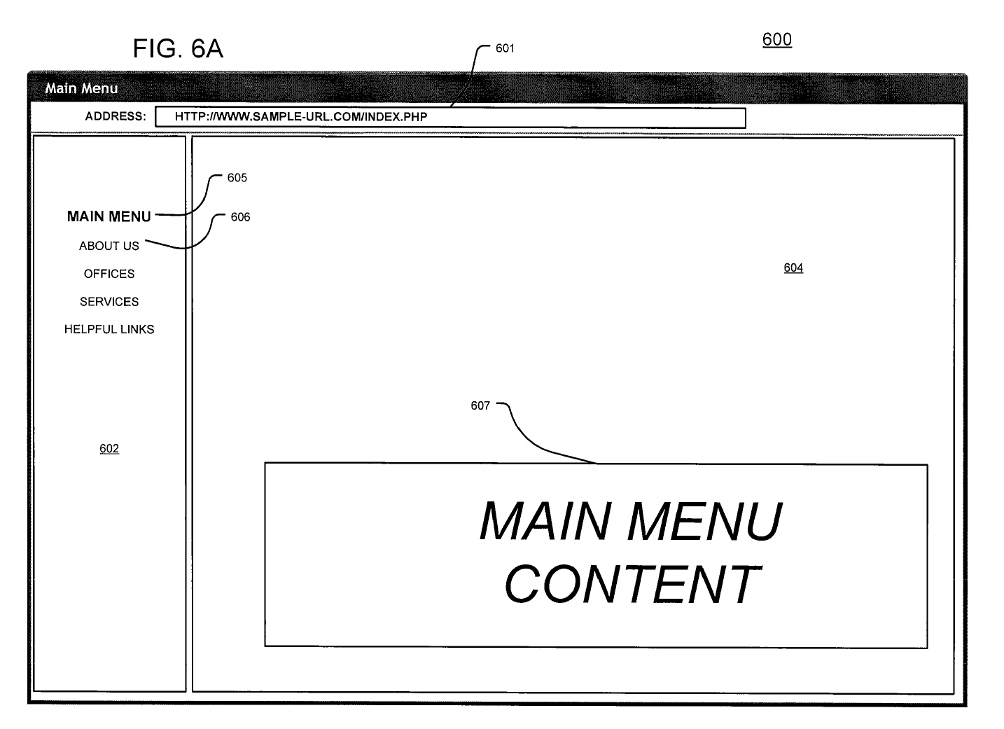

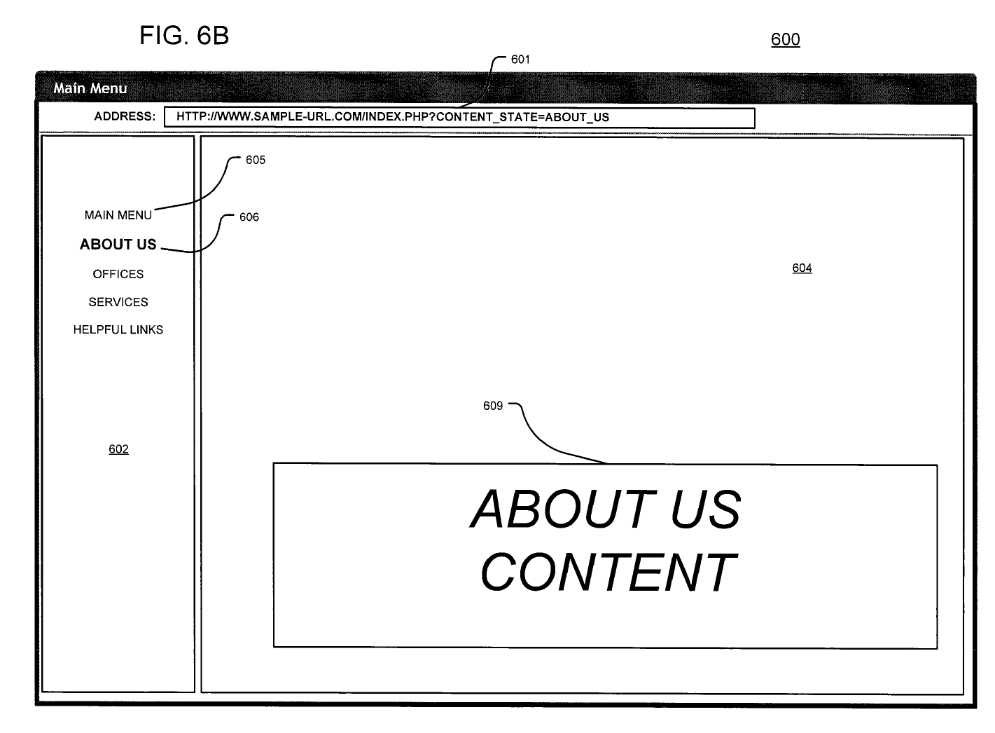

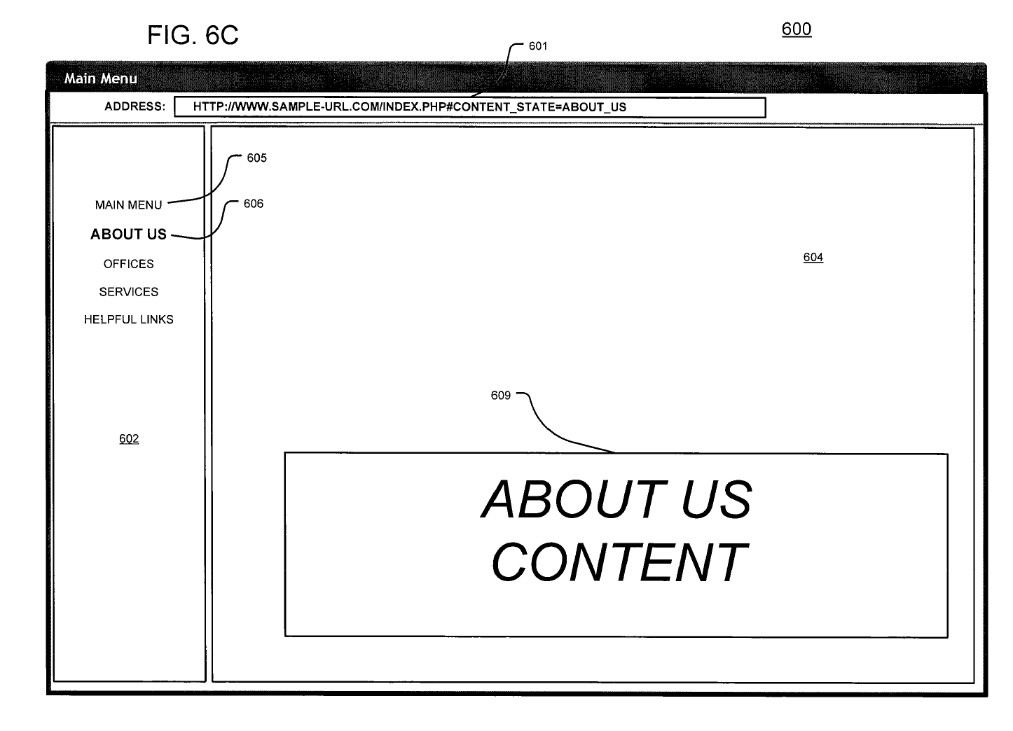

One example Ajax panel could represent a menu bar including menu links that, when selected, change information displayed in a main display panel. Another example Ajax panel could represent computer resources including resource links that, when selected, access and display information relating to a computer resource. In either case, a selection of a link causes a portion of the page to load and display information if JavaScript is sufficiently enabled, or causes the entire page to load and display information if JavaScript is insufficiently enabled. As described in more detail, below, FIGS. 6A to 6C illustrate other exemplary Ajax panels.

In the exemplary system 100, the client 101 may be used by a web developer to create web documents, and by a user to view the web documents. In a further, non-depicted example, these functions occur using different devices. For example, the client 101 may include multiple discrete devices, such as a first client device that includes the web development application 105 but not the web browser 106, and a second client device that includes the web browser 106 but not the web development application 105.

The server 102 further includes a server scripting language engine 111 that gives the server a server scripting language processing capability, as well as stored web documents 112. In various example implementations, the server scripting language engine 111 allows the server 102 to render pages using PHP, ColdFusion, ASP, JSP, RAILS, or any other server-side scripting language.

The stored web documents 112 are catalogued by metadata that describes their associated states, such as in a look-up table. Based on HTTP requests for a particular state received from the client 101 via the network 104, the server 102 locates a file corresponding to the state using the metadata index, and transmits the web documents 112 or portions of the web documents 112 back to the client 101. The stored web documents 112 may include Ajax panels that are cataloged using the metadata to include all associated default states and available states.

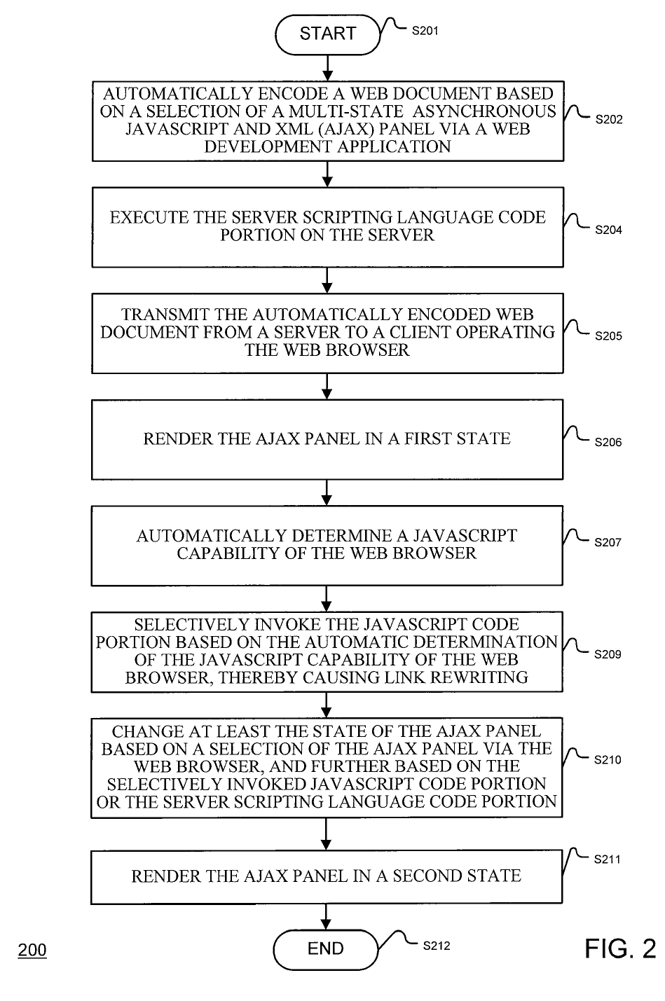

FIG. 2 is a flowchart illustrating an exemplary process 200 for implementing automatically encoded, gracefully degrading Ajax panels, according to one general implementation. Although the exemplary process 200 is shown as including both a web document creation sub-process (S202) and a web document rendering sub-process (S205 to S211), either of these sub-processes may be combined, selectively omitted, or re-ordered as appropriate to satisfy a user's requested functionality. For example, in one alternate implementation, the Ajax panels are not automatically-encoded, but rather they are hand-coded in a PHP document without using an IDE.

Briefly, the process 200 includes automatically encoding a web document based on a selection of a multi-state Ajax panel via a web development application, the encoded web document including a JavaScript code portion and a server scripting language code portion corresponding to the Ajax panel. A JavaScript capability of a web browser is automatically determined, the JavaScript code portion is selectively invoked based on the automatic determination of the JavaScript capability of the web browser, the state of at least the Ajax panel is changed based on a selection of the Ajax panel via the web browser, and further based on the selectively invoked JavaScript code portion or the server scripting language code portion, and the Ajax panel is rendered.

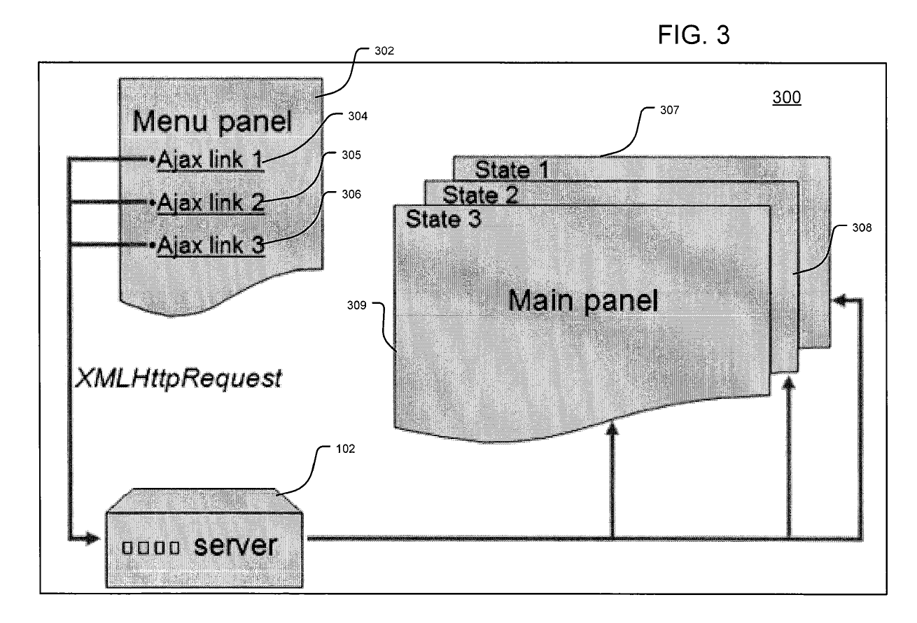

By way of background, FIG. 3 illustrates the general relationship between states of an Ajax panel for an exemplary web document 300. A web document 300 may include an Ajax panel 302 that displays a menu, and a main panel whose displayed content (referred to as ‘microcontent’) depends on user events happening to the links on the Ajax panel 302. The Ajax panel 302 includes links, such as links 304 to 306 that, when selected, change the state of the web document. These links, which may also be Ajax controls or Ajax widgets, are also referred to as ‘microlinks,’ since they are intended to open new content on an existing page rather than load a new page. Although the state of the Ajax panel 302 itself stays the same and does not change, the state of the main (i.e. the content displayed in the main panel) changes depending upon the link on the Ajax panel 302 selected by the user.

For example, if the web document 300 represents the default home page of a retail store, the Ajax panel 302 may include a ‘home’ link 304, a ‘contact us’ link 305, and a ‘product catalog’ link 306. When the ‘home’ link 304 is selected or clicked, default content information corresponding to state 307 is displayed in the main panel. When the ‘contact us’ link 305 is selected or clicked, contact information corresponding to state 308 is displayed in the main panel. Similarly, when the ‘product catalog’ link 306 is selected or clicked, product information corresponding to state 309 is displayed in the main panel.

When Ajax is enabled, the user selection of a link will trigger the main panel to refresh with the appropriate content information, using JavaScript processed on the client device. With this approach, it is not necessary for the server to rebuild the entire page, for example by rebuilding the Ajax panel 302, since that information is static. Where Ajax is disabled or missing, the user selection of a link will trigger the entire web document to refresh, since the client device does not have the capability to refresh just the menu panel. With this latter approach, the server 102 rebuilds the entire page, including the Ajax panel 302 and the main page. Although this latter approach is more computationally-expensive to the server, it allows for graceful degradation of the web document. A further example of this enhanced approach is provided in FIGS. 6A to 6C.

An Ajax-enabled site may include one or more master web documents that represent the actual files loaded in the browser when accessing a URL. Each master web document may include an Ajax panel that users can place anywhere on the site, where each Ajax panel includes other web documents representing each state. The Ajax panel 302 has one or more states, such as states 307 to 309, which represent the actual files included in the web site when an Ajax request is performed.

Using JavaScript, a state is called by the client upon the selection of an Ajax link, via an XMLHTTPREQUEST sent from the client to the server. This selection could be a mouse click, a keyboard keystroke, a touch of a touch-screen display, or any human-computer interaction intended to signify a manipulation or interaction with the desired link. If JavaScript is disabled, a state is called by the client upon the selection of an Ajax link, via an HTTP request sent from the client to the server. In either regard, since the various web documents representing the various states, panels and pages are catalogued using metadata, the server uses a look-up table to determine the location of the stored web document based upon the state requested by the client.

Referring back to FIG. 2, the process 200 begins (S201) when a web document is automatically encoded based on a selection of a multi-state Ajax panel via a web development application. (S202). The encoded web document includes a JavaScript code portion and a server scripting language code portion corresponding to the Ajax panel. An Ajax panel, which includes at least a first state, may be an Ajax widget or other Ajax control. The Ajax panel may also include other content data, such as HTML content, images and text.

Instead of manually programming multi-state Ajax panels into a web document, a web developer can use a web development application such as the ADOBE® DREAMWEAVER® web development application or another WYSIWYG web development application to automatically encode the Ajax panel. For example, using a web development application, a user can select an Ajax panel template or wizard and define properties or attributes of the Ajax panel, and code for the Ajax panel is automatically encoded into the web document.

Working with Ajax panels in such a manner is intuitive to web developers, since the approach is similar to using editable regions in applications, such as ADOBE® DREAMWEAVER® templates, or using master pages in MICROSOFT® VISUAL STUDIO®. Web developers may easily design a web document that displays and hides portions of content by defining events that change the page layout, making content appear or disappear in a specific context. Using a WYSIWYG web development application, default commands and server behaviors from the web, such as record sets, forms, navigation bars or repeat regions, can be combined with the selected Ajax panels. The automatically-encoded web document includes a JavaScript code portion and a server scripting language code portion corresponding to the Ajax panel.

Since Ajax panels have multiple parameters and can be reused across multiple master web documents, development time may be reduced. For instance, the menu Ajax panel 302 can be reused on other web documents on a web site that a developer is developing, where the menu Ajax panel 302 can be defined once and reused on each web document without rebuilding the panel.

As such, the links on the automatically encoded Ajax panel 302 may call a server-side function or object method using JavaScript, causing a response to be asynchronously sent from the server 102 back to the client, or the links may be processed via a client-side function without using JavaScript. The links may be used by a designer to implement a variety of form validation routines, such as checking whether a username already exists on the user registration form. These routines may work in real-time, for example before a form is submitted to the server.

Automatic encoding of Ajax panels in web documents allows for rapid application development, with little or no actual JavaScript programming skills. Automatic encoding can be used with the PHP_MYSQL, COLDFUSION, and ASP_VBSCRIPT server models, bringing the benefits Ajax panels to static HTML sites, using WYSIWYG web development. Accordingly, even inexperienced web developers can build Ajax functionalities into their web sites using an established web design workflow, without time consuming and confusing hand-coding. This intuitive approach has a lean learning curve, making it easier for web developers of all skill levels to implement complex web document design.

A web developer can offer the benefit of Ajax panel to clients and site visitors, using a toolkit designed for legacy web development applications. Such a toolkit may provide, for example, a template-based engine for working with Ajax panels, or a quick-start wizard for generating an entire Ajax website, step-by-step wizards and server behaviors accessible from a menu bar and or panel. Furthermore, property inspectors may be used for easily changing the properties of Ajax panels, and an Ajax Panels tab may be used for easily managing site content and structure. Right-click menus may also be used for editing the content of Ajax panel states, and a cascading style sheet (CSS) can be quickly customized using a CSS styles menu or panel.

In another implementation, the Ajax panels are manually-coded in a web document without using an IDE, and the automatic encoding sub-process (S202) is omitted.

The server scripting language code portion is executed on the server (S204), and the result of the execution is sent to the client for rendering via the web browser (S205). For example, the result of PHP code execution on the server may be HTML and JavaScript, which is output on the web browser, depending on the capabilities of the web browser.

By way of example, FIGS. 6A illustrates an exemplary web document 600 that may have been automatically encoded, and that has been received by a client operating a web browser and loaded. By loading the server scripting language code portion of the web document 600, whose address (shown in address bar 601) is HTTP://WWW.SAMPLE-URL.COM/INDEX.PHP, a default home page is displayed. The web document 600 includes a menu panel 602, and a main panel 604. The panel includes links, including (amongst others) a selected ‘main menu’ link 605 and an ‘about us’ link 606.

Each link corresponds to a state of the main panel, where content associated with each state is displayed in the main menu 604. For example, the manual or automatic selection of the ‘main menu’ link 605 results in the rendering of ‘main menu’ content 607 in the main panel 604. In a further non-depicted implementation, the web document 600 includes more than two panels, such as an advertising panel that also changes with the selection of a link.

The Ajax panel is rendered, in a first state (S206). As shown in FIG. 6A, the first state may be a default state, which displays main menu content 607 or other text making up the body or title of a web document. The Ajax panel may be rendered in a web browser of a client device of a user who is not the web developer, or the Ajax panel may be rendered using the web development application, such as when the web developer uses a preview function to view a web document that they are in the process of creating or have created. Previewing a web document may or may not involve live communication with a remote server.

The web document 600 may represent a RIA that interacts with web site visitors, offering them a unique web experience. If the web browser is JavaScript enabled, a user can continue using the menu panel 602 while main panel 604 loads separately and asynchronously. Using the server scripting language code portion encoded in the web document 600, the first rendering is fast, while JavaScript files in the background are incrementally loaded in the background. Even on a slow connection such as a dial-up connection, a user can quickly see and interact with the web document 600.

Communication between the server 102 and client 101 is provided for based on the specific capabilities of the web browser. For example, if the web browser is a smart (fourth generation or later) web browser, the web document may be incrementally or asynchronously transmitted from the server 102 to the client 101, by transferring sections of the document using an XMLHTTPREQUEST. For web browsers with limited processing capabilities, however, transmission and reception of the web document by transferring the whole page, including all panels and surrounding content with each link selection.

A JavaScript capability of a web browser is automatically determined (S207). A JavaScript capability refers to an ability of a web browser to process JavaScript scripts, and may depend upon the existence of a JavaScript engine, a user setting enabling the processing of JavaScript scripts, or other attributes. In this regard, the automatic determination may determine whether the web browser is a fourth generation or later web browser, or whether JavaScript is disabled or missing. By ‘JavaScript capability,’ it is intended that a quantification or metric indicative of a web browser's ability to process JavaScripts be measured. This quantification may be a binary quantification, such as if the JavaScript capability has only an enabled or disabled state, or the quantification may have a range of values if certain but not all JavaScript functions are enabled, or if older JavaScript engines are detected.

Since Ajax-enabled web documents heavily rely on JavaScript and may provide limited functionality or no functionality if JavaScript is disabled, a server scripting language is used as a fallback mechanism whenever JavaScript is missing or disabled. Accordingly the automatic determination of the JavaScript capability of the web browser is used to determine the appropriate component used to correctly generate the web documents.

Since web documents are appropriately rendered regardless of the JavaScript capabilities of the web browser, the web documents are accessible to screen readers, and can be indexed by search engines, such as the GOOGLE® search engine. Content is thus available to those with disabilities, and search engine ranking is not be affected by the added Ajax panels.

The JavaScript code portion is selectively invoked based on the automatic determination of the JavaScript capability of the web browser (S209). The JavaScript code portion may be invoked if it is automatically determined that JavaScript is not disabled or missing. If JavaScript is enabled, the links that change the panel states are converted (or ‘rewritten’) into Ajax controls or components.

The selectively invoked JavaScript code portion causes the URLs of the web document to be rewritten. Specifically, the JavaScript code portion changes or updates the DOM structure in the memory of the web browser, assigning an ONCLICK event to the respective links on the Ajax panel. In this regard, upon receiving a user selection of the link, the ONCLICK event executes on the client to update or change the state of at least the panel. If JavaScript is not enabled, the ONCLICK event is not assigned to the link, and a user selection of the links causes the issuance of a HTTP request for a PHP document stored on the server.

In this regard, the user selection of the Ajax panel via the web browser is seen to be hijacked or intercepted, and a default action of the user selection of the Ajax panel via the web browser may be modified based on the automatic determination of the JavaScript capability of the web browser. In particular, when a user clicks a link to change the state of the panel, the interaction with the link is hijacked or intercepted by a client-side component, and wrapped by the handler call. This handler call also determines the capabilities of the client and, if sufficient capabilities are detected, changes the default action resulting from the interaction. For instance, for JavaScript-enabled web browsers, the handler call retransmits a non-modified request to the server. For the browsers that do not support Ajax, such as non-JavaScript-enabled web browsers, a HTTP request is transmitted for a PHP page, including the serialized desired state of the panels in the URL as GET parameters.

The state of at least the Ajax panel is changed based on a selection of the Ajax panel via the web browser, and further based on the selectively invoked JavaScript code portion or the server scripting language code portion (S210). For example, the state of the Ajax panel may be changed by default, or if a user selects a URL or other portion of the Ajax panel. If the web browser is sufficiently capable of processing JavaScript, it may be that just the Ajax panel changes. If the web browser is not sufficiently capable of processing JavaScript, the whole web document may have to be refreshed or reloaded in order to update the state of the Ajax panel. In this regard, ‘at least’ the Ajax panel changes based on the various code portions and processing capabilities.

The second state of the Ajax panel may also be serialized in a URL of the web document using a hash or GET variables. By automatically serializing the state of a web application in the URL using hashes (for Ajax requests in JavaScript-enabled clients), and GET variables (for requests in non-JavaScript enabled clients), the browser history may be synchronized with the application state. Thus, bookmarking may occur, and the web browser's “Back” and “Forward” controls function intuitively, as occurs with most server-side applications.

Functional navigation controls and bookmarking provide an enhancement over legacy Ajax-enabled application, which do not implement these features. By serializing the state of the application in the URL, the web browser will not lose the state of an underlying application, even if a refresh operation is performed. In this regard, in addition to enriched Ajax behavior, the web browser also receives the typical benefits associated with server-side web applications.

The Ajax panel is rendered in the second state via the web browser (S211), thereby ending the process 200 (S212). Thus, states of an Ajax panel are rendered in a web browser using either an automatically-encoded JavaScript code portion or an automatically-encoded non-JavaScript code portion of a web document, based on an automatic determination of a JavaScript capability of the web browser.

FIGS. 6B and 6C illustrate the web document 600 in a second state, as rendered on a web browser with limited JavaScript capabilities and a web browser with sufficient JavaScript capabilities, respectively. In both FIGS. 6B and 6C, identical ‘about us’ content 609 is displayed in the main panel 604, as a result of the user selecting link 606 in the menu panel 602. In FIG. 6B, however, the ‘about us’ content 609 was rendered via an HTTP request to the server, which refreshed the entire web document 600. In FIG. 6C, the ‘about us’ content 609 was rendered a JavaScript function invoked on the client device. This difference is serialized in the slightly-different URL displayed in the respective address bar 601, which displays a ‘#’ before the content state data in the JavaScript implementation, and which displays a ‘?’ before the content state data in the non-JavaScript implementation. As desired, since the user experience of the web document is the same regardless of the capabilities of the web browser, the web document 600 takes advantage of graceful degradation.

When JavaScript is enabled, the URL changes using hashes, resulting in bookmark-able pages, and in correctly functioning ‘back’ and ‘forward’ navigation controls. These are notable advantageous features over typical Ajax panels, which cannot implement these functionalities since the URL does not change with each state change.

In a non-depicted example implementation that includes more than two panels, a third panel can display additional content, such as advertising content. When selecting a first link, a non-JavaScript implementation may reference the URL HTTP://WWW.SAMPLE-URL.COM/INDEX.PHP?CONTENT_STATE=ABOUT_US&ADS_STATE=AD1 to change the state of the main panel 604 to display the ‘about us’ content 609 and change the state of the ad panel to display ad content associated with the metadata AD1. When selecting a second link, the non-JavaScript implementation may reference the URL HTTP://WWW.SAMPLE-URL.COM/INDEX.PHP?CONTENT_STATE=SERVICES&ADS_STATE=AD2 to change the state of the main panel 604 to display ‘services’ content and change the state of the ad panel to display ad content associated with the metadata AD2.

Notably, although FIGS. 6B and 6C represent a different state (and two additional files) than the state illustrated in FIG. 6A, a web developer need not re-code the Ajax-enabled menu panel 602 for each of the two additional files. Instead, using an established development workflow, the web developer need merely copy the Ajax-enabled menu from a first file corresponding to the first state shown in FIG. 6A, and paste that same Ajax-enabled menu into the files corresponding to FIGS. 6B and 6C. This approach is time-saving and convenient, for novice and expert web developers alike.

Unlike other attempts at graceful degradation of Ajax panels, the application logic is automatically duplicated from the server to the client, thus reducing the amount of work necessary to develop the web document. In this regard, it is not necessary to manually duplicate application logic on both server and client in order to provide the same functionality on non-JavaScript enabled clients. Such an enhanced approach can be used both to build web sites with Ajax panels from scratch, and to update legacy websites with interactive Ajax controls and widgets.

Another general implementation provides for the automatic encoding a web document (S202), and does not necessarily provide for the rendering of the web document itself (S204 to S2 11). According to this implementation, a computer-implemented method includes automatically encoding a web document based on a selection of a multi-state Ajax panel via a web development application, the encoded web document including a JavaScript code portion and a server scripting language code portion corresponding to the Ajax panel, the JavaScript code portion and the server scripting language code portion being operable to cause a change of state of at least the Ajax panel based on a selection of the Ajax panel via a web browser.

Another general implementation provides for the rendering of the web documents (S207 to S211), and does not necessarily provide for the automatic encoding of the web document itself (S202 to S206). According to this implementation, a computer-implemented method includes loading a server scripting language code portion of a web document using a web browser, the web document being automatically encoded based on a selection of a multi-state Ajax panel via a web development application, and automatically determining a JavaScript capability of the web browser. A JavaScript code portion of the web document is selectively invoked based on the automatic determination of the JavaScript capability of the web browser, the state of at least the Ajax panel is changed based on a selection of the Ajax panel via the web browser, and further based on the selectively invoked JavaScript code portion or the server scripting language code portion, and the Ajax panel is rendered.

While the enhanced approach described above has been described above in the context of Ajax panels, JavaScript, and PHP, such description is merely exemplary, and other controls, components, languages, uses, techniques, interfaces and approaches may also be used. For example, according to another general implementation, a web document is automatically encoded based on a selection of a multi-state panel via a web development application, the encoded web document including a first code portion and a second code portion corresponding to the panel, loading the second code portion using a web browser, and a capability of the web browser is automatically determined. The first code portion is selectively invoked based on the automatic determination of the capability of the web browser, the state of at least the panel is changed based on a selection of the panel via the web browser, and further based on the selectively invoked first code portion or the second code portion, and the panel is rendered.

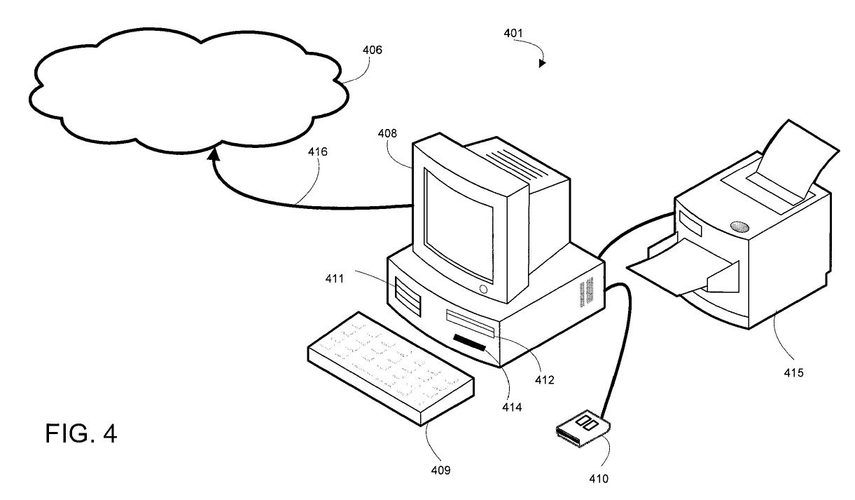

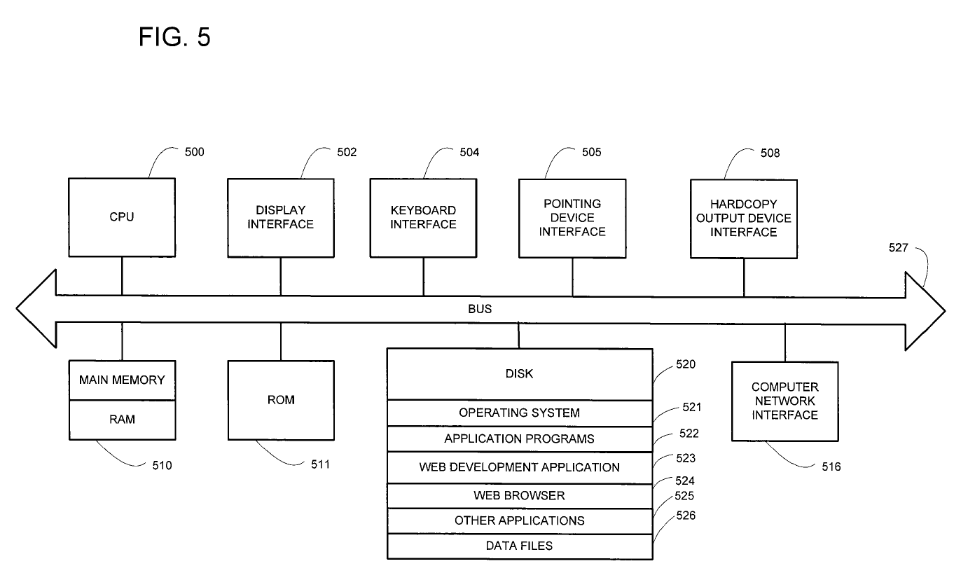

FIG. 4 depicts the exterior appearance of an exemplary client device 401 that, according to another general implementation, functions as the client 101. FIG. 5 depicts an exemplary internal architecture of the client device 401. Briefly, the client device 401 includes a central processing unit 500 and a display monitor 408. The central processing unit 500 is configured to automatically encode a web document based on a selection of a multi-state Ajax panel via a web development application, the encoded web document including a JavaScript code portion and a server scripting language code portion corresponding to the Ajax panel, to load the server scripting language code portion using a web browser, to automatically determine a JavaScript capability of the web browser, to selectively invoke the JavaScript code portion based on the automatic determination of the JavaScript capability of the web browser, and to change the state of at least the Ajax panel based on a selection of the Ajax panel via the web browser, and further based on the selectively invoked JavaScript code portion or the server scripting language code portion. The display monitor 408 is configured to render the Ajax panel.

In more detail, the hardware environment of the client device 401 includes a display monitor 408 for displaying text and images to a user, a keyboard 409 for entering text data and user commands into the client device 401, a mouse 410 for pointing, selecting and manipulating objects displayed on the display monitor 408, a fixed disk drive 411, a removable disk drive 412, a tape drive 414, a hardcopy output device 415, and a computer network connection 416.

The display monitor 408 displays the graphics, images, and text that includes the user interface for the software applications used by the client device 401, as well as the operating system programs necessary to operate the client device 401. A user uses the keyboard 409 to enter commands and data to operate and control the computer operating system programs as well as the application programs. The user uses the mouse 410 to select and manipulate graphics and text objects displayed on the display monitor 408 as part of the interaction with and control of the client device 401 and applications running on the client device 401. The mouse 410 is any type of pointing device, and may be a joystick, a trackball, a touch-pad, or other pointing device. A digital input device may also be included to allow the client device 401 to capture digital images, and may be a scanner, a digital camera, a digital video camera, or other digital input device. Software used to provide for automatically-encoded, gracefully degrading Ajax panels is stored locally on computer readable memory media, such as the fixed disk drive 411.

In a further implementation, the fixed disk drive 411 itself may include a number of physical drive units, such as a redundant array of independent disks (“RAID”), or may be a disk drive farm or a disk array that is physically located in a separate computing unit. Such computer readable memory media allow the client device 401 to access computer-executable process steps, application programs and the like, stored on removable and non-removable memory media.

The wireless or wireline computer network connection 416 may be a modem connection, a local-area network (“LAN”) connection including the Ethernet, or a broadband wide-area network (“WAN”) connection such as a digital subscriber line (“DSL”), cable high-speed internet connection, dial-up connection, T-1 line, T-3 line, fiber optic connection, or satellite connection. The network 406 may be one or more of a LAN network, a corporate or government WAN network, the Internet, or other network.

The computer network connection 416 uses a wireline or wireless connector. Example wireless connectors include, for example, an INFRARED DATA ASSOCIATION® (“IrDA®”) wireless connector, an optical wireless connector, an INSTITUTE OF ELECTRICAL AND ELECTRONICS ENGINEERS® (“IEEE®”) Standard 802.11 wireless connector, a BLUETOOTH® wireless connector, a near field communications (“NFC”) connector, an orthogonal frequency division multiplexing (“OFDM”) ultra wide band (“UWB”) wireless connector, a time-modulated ultra wide band (“TM-UWB”) wireless connector, or other wireless connector. Example wireline connectors include, for example, an IEEE®-1394 FIREWIRE® connector, a Universal Serial Bus (“USB”) connector, a serial port connector, a parallel port connector, or other wireline connector.

The removable disk drive 412 is a removable storage device that is used to off-load data from the client device 401 or upload data onto the client device 401. The removable disk drive 412 may be a floppy disk drive, an IOMEGA® ZIP® drive, a compact disk-read only memory (“CD-ROM”) drive, a CD-Recordable drive (“CD-R”), a CD-Rewritable drive (“CD-RW”), flash memory, a USB flash drive, an external hard disk drive, thumb drive, pen drive, key drive, a High-Density Digital Versatile Disc (“HD-DVD”) optical disc drive, a Blu-Ray optical disc drive, a Holographic Digital Data Storage (“HDDS”) optical disc drive, or any one of the various recordable or rewritable digital versatile disc (“DVD”) drives such as the DVD-Recordable (“DVD-R” or “DVD+R”), DVD-Rewritable (“DVD-RW” or “DVD+RW”), or DVD-RAM. Operating system programs, applications, and various data files, are stored on disks, which are stored on the fixed disk drive 411 or on removable media for the removable disk drive 412.

The tape drive 414 is a tape storage device that is used to off-load data from the client device 401 or to upload data onto the client device 401. The tape drive 414 may be a quarter-inch cartridge (“QIC”), 4 mm digital audio tape (“DAT”), 8 mm digital linear tape (“DLT”) drive, or other type of tape.

The hardcopy output device 415 provides an output function for the operating system programs and applications. The hardcopy output device 415 may be a printer or any output device that produces tangible output objects, including textual or image data or graphical representations of textual or image data. While the hardcopy output device 415 is depicted as being directly connected to the client device 401, it need not be. For instance, the hardcopy output device 415 may be connected to device 401 via a network interface, such as a wireline or wireless network.

Furthermore, although the client device 401 is illustrated in FIG. 4 as a desktop PC, in further implementations the client device 401 may be a laptop, a workstation, a midrange computer, a mainframe, an embedded system, telephone, a handheld or tablet computer, a PDA, or other type of computer.

FIG. 5 depicts an example of an internal architecture of the client device 401. The computing environment includes a computer central processing unit (“CPU”) 500 where the computer instructions that comprise an operating system or an application are processed; a display interface 502 which provides a communication interface and processing functions for rendering graphics, images, and texts on the display monitor 408; a keyboard interface 504 which provides a communication interface to the keyboard 409; a pointing device interface 205 which provides a communication interface to the mouse 410 or an equivalent pointing device; a hardcopy output device interface 508 which provides a communication interface to the hardcopy output device 415; a random access memory (“RAM”) 510 where computer instructions and data are stored in a volatile memory device for processing by the computer CPU 500; a read-only memory (“ROM”) 511 where invariant low-level systems code or data for basic system functions such as basic input and output (“I/O”), startup, or reception of keystrokes from the keyboard 409 are stored in a non-volatile memory device; a storage 520 or other suitable type of memory (e.g. such as random-access memory (“RAM”), read-only memory (“ROM”), programmable read-only memory (“PROM”), erasable programmable read-only memory (“EPROM”), electrically erasable programmable read-only memory (“EEPROM”), magnetic disks, optical disks, floppy disks, hard disks, removable cartridges, flash drives), where the files that comprise an operating system 521, application programs 522 (including web development application 523, web browser 524, and other applications 525 as necessary) and data files 526 are stored; and a computer network interface 516 which provides a communication interface to the network 406 over the computer network connection 416. The constituent devices and the computer CPU 500 communicate with each other over the computer bus 527.

The web development application 523 may be, for example the ADOBE® DREAMWEAVER® web development application, the NETSCAPE® COMPOSER® web development application, the MICROSOFT® FRONTPAGE® web development application, or other applications. The web browser application 524 may be, for example, the MICROSOFT® INTERNET EXPLORER® web browser, the MOZILLA® FIREFOX® web browser, the APPLE® SAFARI® web browser, or the OPERA® web browser, or the Camino web browser. Fourth generation web browsers include MOZILLA® FIREFOX® version 1.0 and later web browsers, the MICROSOFT® INTERNET EXPLORER® versions 6.0 and later web browsers, the APPLE® SAFARI® versions 2.0 and later web browsers, and the OPERA® versions 9.0 and later web browsers.

Briefly, the computer program product is tangibly embodied in a machine-readable medium. The computer program product includes instructions that, when read by a machine, operate to cause a data processing apparatus to automatically encode a web document based on a selection of a multi-state Ajax panel, the encoded web document including a JavaScript code portion and a server scripting language code portion corresponding to the Ajax panel, to load the server scripting language code portion using a web browser, and to automatically determine a JavaScript capability of the web browser. Further, the computer program product also includes instructions that, when read by a machine, operate to cause a data processing apparatus to selectively invoke the JavaScript code portion based on the automatic determination of the JavaScript capability of the web browser, to change the state of at least the Ajax panel based on a selection of the Ajax panel via the web browser, and further based on the selectively invoked JavaScript code portion or the server scripting language code portion, and to render the Ajax panel.

The RAM 510 interfaces with the computer bus 527 so as to provide quick RAM storage to the computer CPU 500 during the execution of software programs such as the operating system application programs, and device drivers. More specifically, the computer CPU 500 loads computer-executable process steps from the fixed disk drive 411 or other memory media into a field of the RAM 510 in order to execute software programs. Data is stored in the RAM 510, where the data is accessed by the computer CPU 500 during execution.

Also shown in FIG. 5, the client device 401 stores computer-executable code for an operating system 521, and application programs 522 such as word processing, spreadsheet, presentation, gaming, or other applications. Although it is possible to provide for automatically-encoded, gracefully degrading Ajax panels using the above-described implementation, it is also possible to implement the functions according to the present disclosure as a dynamic link library (“DLL”), or as a plug-in to other application programs such as an Internet web-browser such as the MICROSOFT Internet Explorer web browser.

The computer CPU 500 is one of a number of high-performance computer processors, including an INTEL® or AMD® processor, a POWERPC® processor, a MIPS® reduced instruction set computer (“RISC”) processor, a SPARC® processor, an ACORN® RISC Machine (“ARM®”) architecture processor, a HP ALPHASERVER® processor or a proprietary computer processor for a mainframe. In an additional arrangement, the computer CPU 500 is more than one processing unit, including a multiple CPU configuration found in high-performance workstations and servers, or a multiple scalable processing unit found in mainframes.

The operating system 521 may be MICROSOFT® WINDOWS NT®/WINDOWS® 2000/WINDOWS® XP Workstation; MICROSOFT® WINDOWS VISTA®/WINDOWS NT®/WINDOWS® 2000/WINDOWS® XP Server; a variety of UNIX®-flavored operating systems, including AIX® for IBM® workstations and servers, SUNOS® for SUN® workstations and servers, LINUX® for INTEL® CPU-based workstations and servers, HP UX WORKLOAD MANAGER® for HP® workstations and servers, IRIX® for SGI® workstations and servers, VAX/VMS for Digital Equipment Corporation computers, OPENVMS® for HP ALPHASERVER®-based computers, MAC OS® X for POWERPC® based workstations and servers; SYMBIAN OS®, WINDOWS MOBILE® or WINDOWS CE®, PALM®, NOKIA® OS (“NOS”), OSE®, or EPOC® for mobile devices, or a proprietary operating system for computers or embedded systems. The application development platform or framework for the operating system 521 may be: BINARY RUNTIME ENVIRONMENT FOR WIRELESS® (“BREW®”); Java Platform, Micro Edition (“Java ME”) or Java 2 Platform, Micro Edition (“J2ME®”); PYTHON™, FLASH LITE®, or MICROSOFT® .NET Compact.

While FIGS. 4 and 5 illustrate one possible implementation of a computing system that executes program code, or program or process steps, configured to effectuate automatically-encoded, gracefully degrading Ajax panels, other types of computers may also be used as well.

Finally, it is noted that, for the sake of brevity, the term “JavaScript” is intended to reference the SUN MICROSYSTEMS® JAVASCRIPT® programming language, and the term “XML” is intended to reference ‘eXtensible Markup Language’ throughout.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising automatically encoding a web document based on a selection of a multi-state Asynchronous JavaScript and XML (Ajax) panel via a web development application, the encoded web document comprising a JavaScript code portion and a server scripting language code portion corresponding to the Ajax panel, the JavaScript code portion and the server scripting language code portion being operable to cause a change of state of at least the Ajax panel based on a selection of the Ajax panel via a web browser.

2. The method of claim 1, wherein the Ajax panel further comprises an Ajax control or widget.

3. The method of claim 1, wherein the server scripting language is Hypertext Preprocessor (PHP).

4. The method of claim 1, wherein the selection of the Ajax panel via the web development application comprises a user selection of an Ajax panel template or wizard.

5. The method of claim 1, wherein the selection of the Ajax panel via the web development application comprises a user selection via a What You See Is What You Get (WYSIWYG) web development application.

6. A computer program product tangibly embodied in a machine-readable medium, the computer program product comprising instructions that, when read by a machine, operate to cause a data processing apparatus to:
automatically determine a JavaScript capability of a web browser;
selectively invoke a JavaScript code portion of a web document based on the automatic determination of the JavaScript capability of the web browser, the web document being automatically encoded based on a selection of a multi-state Asynchronous JavaScript and XML (Ajax) panel;
change the state of at least the Ajax panel based on a selection of the Ajax panel via the web browser, and further based on the selectively invoked JavaScript code portion or a server scripting language code portion of the web document; and
render the Ajax panel.

7. The computer program product of claim 6, wherein automatically determining a JavaScript capability of the web browser further comprises automatically determining whether JavaScript is disabled or missing.

8. The computer program product of claim 6, wherein invoking the JavaScript code portion or the server scripting language code portion based on the automatic determination of the JavaScript capability of the web browser effectuates graceful degradation of the encoded web document.

9. The computer program product of claim 6, wherein the JavaScript code portion is invoked if it is automatically determined that JavaScript is not disabled or missing, and wherein the server scripting language code portion is invoked if it is automatically determined that JavaScript is disabled or missing.

10. The computer program product of claim 6, further comprising instructions that, when read by a machine, operate to cause a data processing apparatus to serialize the state of the Ajax panel in a Uniform Resource Locator (URL) of the web document.

11. The computer program product of claim 10, wherein the state of the Ajax panel is serialized using a hash.

12. The computer program product of claim 10, wherein the state of the Ajax panel is serialized using GET variables.

13. The computer program product of claim 6, further comprising instructions that, when read by a machine, operate to cause a data processing apparatus to:
intercept a selection of the Ajax panel via the web browser; and
modify a default action of the selection of the Ajax panel via the web browser based on the automatic determination of the JavaScript capability of the web browser.

14. The computer program product of claim 13, wherein modifying the default action of the selection further comprises modifying a document object model (DOM) structure.

15. A computer-implemented method comprising:
automatically determining a JavaScript capability of a web browser;
selectively invoking a JavaScript code portion of a web document based on the automatic determination of the JavaScript capability of the web browser;
changing a state of at least an Ajax panel based on a selection of the Ajax panel via the web browser, and further based on the selectively invoked JavaScript code portion or a server scripting language code portion of the web document; and
rendering the Ajax panel.

16. The method of claim 15, wherein changing the state of at least the Ajax panel based on the server scripting language code portion further comprises transmitting a request from the client to the server using GET variables.

17. The method of claim 15,
wherein selectively invoking the JavaScript code portion of the web document further comprises assigning an ONCLICK event to a link associated with the Ajax panel, and
wherein, on receiving a user selection of the link, changing the state of at least the Ajax panel further comprises:
executing the ONCLICK event if the web browser is automatically determined to include a JavaScript capability; and
issuing a hypertext transfer protocol (HTTP) request if the web browser is automatically determined to not include a JavaScript capability.

18. A computer-implemented method comprising:
automatically encoding a web document based on a selection of a multi-state panel via a web development application, the encoded web document comprising a first code portion and a second code portion corresponding to the panel;
automatically determining a capability of a web browser;
selectively invoking the first code portion based on the automatic determination of the capability of the web browser;
changing the state of at least the panel based on a selection of the panel via the web browser, and further based on the selectively invoked first code portion or the second code portion; and
rendering the panel.

19. A method comprising rendering states of an Ajax panel in a web browser using either an automatically-encoded JavaScript code portion or an automatically-encoded non-JavaScript code portion of a web document, based on an automatic determination of a JavaScript capability of the web browser.

20. A device comprising:
a processor configured to:
automatically encode a web document based on a selection of a multi-state Asynchronous JavaScript and XML (Ajax) panel, the encoded web document comprising a JavaScript code portion and a server scripting language code portion corresponding to the Ajax panel,
automatically determine a JavaScript capability of a web browser,
selectively invoke the JavaScript code portion based on the automatic determination of the JavaScript capability of the web browser, and
change the state of at least the Ajax panel based on a selection of the Ajax panel via the web browser, and further based on the selectively invoked JavaScript code portion or the server scripting language code portion; and
a display configured to render the Ajax panel.
